(19) United States
(12) Patent Application Publication
(10) Pub. No.: US 2004/0229106 A1
(43) Pub. Date: Nov. 18, 2004

(54) Polymer electrolyte fuel cell and method of replacing same

(75) Inventors: Eiichi Yasumoto, Kyoto (JP); Hideo Ohara, Osaka (JP); Hiroki Kusakabe, Osaka (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Matsushita Electric Industrial Co., Ltd.

(21) Appl. No.: 10/842,727

(22) Filed: May 10, 2004

(30) Foreign Application Priority Data
May 13, 2003 (JP) 2003-134006

(51) Int. Cl. H01M 8/02; H01M 8/10

(52) U.S. Cl. 429/38; 429/32

(57) ABSTRACT

A fuel cell configuration is provided in which a bad single cell found in a stack of cells can be simply removed without destroying the material of the stack. For this purpose, a groove is provided in at least one longitudinal side of the stack between the separators of adjoining fuel cell units. By use of this groove to separate the adjoining fuel cell units, the one bad single cell alone can be easily replaced. The groove may be formed by a simple processing of the edge shapes of one or more the separators.

### BACKGROUND OF THE INVENTION

The present invention is directed to a polymer electrolyte fuel cell and a method for its replacement in a fuel cell stack. More particularly, the invention relates to fuel cells of the type used, for example, in portable power sources, power sources for electric automobiles, and co-generation systems for household use.

The polymer electrolyte fuel cell generates electricity and heat simultaneously by gas diffusion electrodes which electro-chemically react fuel gas, such as hydrogen, and oxidation gas, such as air. The polymer electrolyte fuel cell is fundamentally configured with a polymer membrane which selectively transports hydrogen ions, and a pair of electrodes between which the polymer membrane is interleaved or sandwiched, to form a membrane electrode assembly. The electrodes are made with a catalyst layer, in which the main component is a carbon powder carrying a platinum group metal catalyst, adhered to the polymer membrane, and a gas diffusion layer that has both the properties of gas permeability and electro-conductivity, arranged on the outer side of each electrode. A gas-tight gasket is arranged on the peripheral portion of the polymer membrane.

Electro-conductive separators for mechanically fixing this membrane electrode assembly (MEA), as described above, are provided on the outside of the MEA. The separators electrically connect adjoining MEA's in series. The electro-conductive separator supplies reactive gas to the facing surface of the electrode by providing a gas channel, which also carries off gas generated during the reaction, as well as excess reaction gas. Although the gas channel can be provided independently from the separator, a system in which a groove is provided on a surface of the separator, as a gas channel, is commonly used.

A cooling channel for circulation of cooling water, which keeps the cell temperature constant, is provided on the other side of the separator. The heat energy generated by the reaction can be used to warm circulating cooling water. The gasket is arranged around the electrodes, such that the polymer membrane is sandwiched with a gas tight sealing. Seals, such as O rings, are arranged so fuel gas, oxidation gas, and cooling water do not leak to the outside of the cell and do not mix with each other. So-called internal manifolds, which provide a gas supply channel and an exhaust channel, and a further cooling water supply channel and exhaust channel, are common in this stack type cell.

An entire stack of polymer electrolyte fuel cells, as described above, is bonded together after the components of the separator, the MEA, etc. are sequentially piled up, in order to decrease the resistance of the electrical contact and to prevent the leakage of cooling water. In this process, the problem of incomplete sealing occurs, because as the number of single cells being piled up increases, it becomes more difficult to stack without the cells jolting out of alignment. Ad-ditionally, if a bad cell is found in the stack, the stacked configuration parts must be removed one by one to find the location of the bad cell.

A conventional prior art method, which uses knock pins to prevent jolting out of alignment, is disclosed in Japanese published patent application HEI 9-134734. Additionally, another method is disclosed in Japanese published patent application 2000-48849 (JP 2000-48849 A) for preventing a jolting out of alignment when the cells are stacked, and for replacing a bad cell without causing a jolting out of alignment. This other method provides a notched part on at least one edge of the side of the stack.

However, although the method of using knock pins is effective for preventing a jolting out of alignment, it is problematic because the knock pins keep getting left in the inner part of the cell following re-assembly, and as a result, the cell stack keeps getting bigger and heavier due to the knock out pins. Enormous numbers of man-hours are required for cell replacement, because the stacked cell units must be pulled out sequentially. The reason for this is that if the above-mentioned knock pin is left inside a face of the cell, the bad cell cannot be taken out when it is found. Additionally, this operation becomes even more difficult if the clearance between the knock pin and the locating hole is small. Moreover, to accomplish this task, normal cells must be removed from the stack. Consequently, there is a possibility that a new sealing problem may occur in the normal cells when they are reassembled.

The method in which a notched part is provided without a knock pin being used can prevent a jolting out of alignment when the cells are stacked. Furthermore, if there is a chance of bad cells existing in the assembled fuel cell stack, the bad cells alone can be replaced by using a lifting jig, because it is fixed with a guidepost fitted into the notched part without using a knock pin. However, it is very hard to insert the lifting jig between the separators, which are adjacent to the bad cell that should be replaced, because the separators are completely connected to each other, as described in JP 2000-8849 A. The insertion of the jig is more difficult according to the method of JP 2000-8849 A, because the lateral side of the fuel cell stack is flat and also because of the precisely determined location of the guidepost. Moreover, if the lifting jig is forcibly inserted, it may cause partial damage to the adjacent separators, due to the configuration of materials used, such as the gas seal, O ring and the like, which may become deformed and may adhere to the separators in stacked cells bonded for a long period under a certain pressure. This may result in the replacement of stacked configuration parts more often than necessary.

### BRIEF SUMMARY OF THE INVENTION

A simple fuel cell configuration and a replacement method for the cell are desired, which make cell extraction easy and replacement possible by targeting the bad cell found in the stack of fuel cells, without destroying or damaging the stacked parts.

In solving these problems, the polymer electrolyte fuel cell of the present invention is stacked with a plurality of single cells, each of which is configured by: a solid polymer membrane; a pair of electrodes which sandwich the solid polymer membrane; an anode side separator, which provides a gas channel for supplying fuel gas to one of the electrodes; and a cathode side separator which provides a gas channel for supplying oxidation gas to the other one of the electrodes. The stack is characterized by at least one groove provided between the adjoining separators of adjacent cells, the groove being provided on at least one side of the stack on a longitudinal side face of the stack.

The cross-sectional shape of the groove(s) provided between the adjoining separators is preferably rectangular or wedge-shaped.

The fuel cell replacement method of the present invention is characterized by the removal and replacement of any single cell from the stack of fuel cells by inserting a cell replacement jig into the groove(s) provided between the adjoining separators.

Based on the present invention, a fuel cell stack can be provided in which a bad single cell can be easily replaced, just by forming an extremely simple configuration of the separator shape.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic longitudinal sectional view of a partial stack of polymer electrolyte fuel cells according to Example 1 of the present invention;

FIG. 2 is a schematic longitudinal sectional view of a partial stack of polymer electrolyte fuel cells according to Example 2 of the present invention;

FIG. 3 is a schematic longitudinal sectional view of a the main part of a partial stack of the polymer electrolyte fuel cells according to Example 3 of the present invention;

FIG. 4 is a schematic longitudinal sectional view of a the main part of a partial stack of polymer electrolyte fuel cells according to Example 4 of the present invention;

FIG. 5 is a schematic longitudinal sectional view of a the main part of a partial stack of the polymer electrolyte fuel cells according to Example 5 of the present invention;

FIG. 6 is a schematic longitudinal sectional view of a partial stack of polymer electrolyte fuel cells according to Example 6 of the present invention;

FIG. 7 is a schematic longitudinal sectional view of a partial stack of fuel cells at the beginning of a replacement method of the present invention;

FIG. 8 is a schematic longitudinal sectional view of a partial stack of fuel cells showing a preliminary step in the removal of normal cells from a bad single cell;

FIG. 9 is a schematic longitudinal sectional view of a partial stack of fuel cells showing the fuel cell before the step in which the bad single cell is removed;

FIG. 10 is a schematic longitudinal sectional view of a partial stack of fuel cells showing the removal of the bad single cell;

FIG. 11 is a schematic longitudinal sectional view of a partial stack of fuel cells showing the setting of a replacement cell in place of the bad single cell;

FIG. 12 is a schematic longitudinal sectional view of a partial stack of fuel cells showing the re-setting of the cells on top of the replacement cell;

FIG. 13 is a schematic longitudinal sectional view of a partial stack of fuel cells in a replacement method of another embodiment of the present invention;

FIGS. 14 (a), (b) and (c) are schematic cross-sectional views of the configuration of the separator grooves according to the embodiments of Examples 1, 2 and 3 of the present invention;

FIGS. 15 (a) and (b) are schematic cross-sectional views of the configuration of the separator grooves according to the embodiment of Example 4 of the present invention;

FIGS. 16 (a) and (b) are schematic cross-sectional views of the configuration of the separator grooves according to the embodiment of Example 5 of the present invention; and

FIG. 17 is a top perspective view of a jig used in carrying out the embodiments of the present invention.

### DETAILED DESCRIPTION OF THE INVENTION

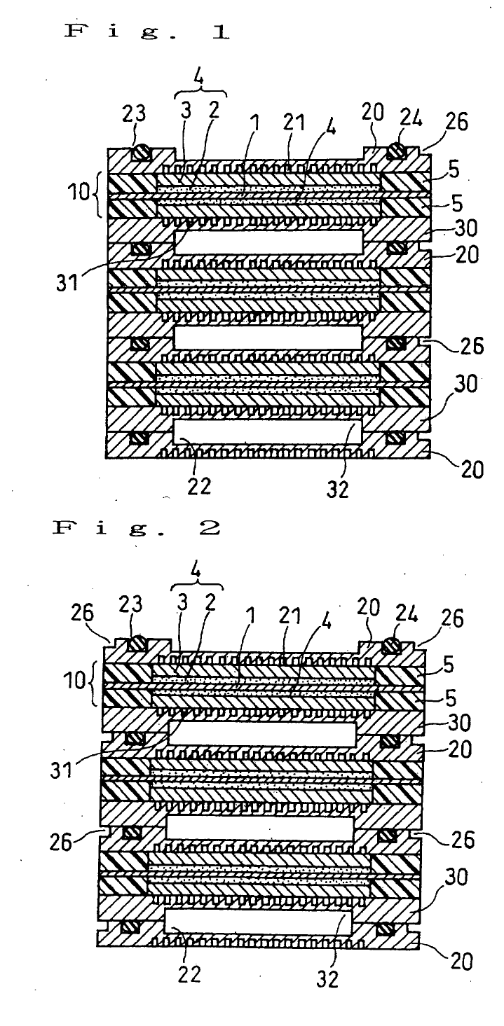

FIG. 1 shows a schematic, longitudinal sectional view of a partial stack of a first embodiment of the fuel cell according to the invention. The membrane electrode assembly (MEA) 10 is configured with polymer membrane 1, a pair of electrodes 4 which sandwich the polymer membrane 1, and gasket 5 which sandwiches the peripheral part of the polymer membrane 1. Each electrode 4 is made up by a catalyst layer 2 and a gas diffusion layer 3, each of which contacts the polymer membrane 1 on the catalyst side. This MEA 10 forms a single cell when the electrodes are sandwiched between separator plates, with the cathode side separator 20 providing gas channel 21 for supplying oxidation gas to the cathode and the anode side separator 30 providing gas channel 31 for supplying fuel gas to the anode.

Cathode side separator 20 and anode side separator 30 also provide channels 22 and 32 on their respective backsides. The channel for cooling water is formed between adjoining single cell separators 20 and 30. The cathode side separator 20 and anode side separator 30 prevent the leakage of cooling water to the outside when compressing the O ring equipped on the concave part 23 of cathode side separator 20 by the bonding pressure which holds the stack of cells together. The above-described configuration is the same as the conventional fuel cell.

The first embodiment of the present invention is characterized by groove 26 for inserting the cell replacement jig between anode side separator 30 and cathode side separator 20, where the concave portion is provided on cathode side separator 20 on its end surface part opposite the anode side separator 30. Although in FIG. 1 a groove is provided on one side of the square shaped separator, groove 26 may favorably be provided on two opposing edges, because it is effective for the replacement of a bad single cell. The groove could alternatively be provided on three or more side edges. Moreover, it is not necessary that the groove extend the entire length of a side, but may instead be only so long as necessary to insert a replacement jig, as described below.

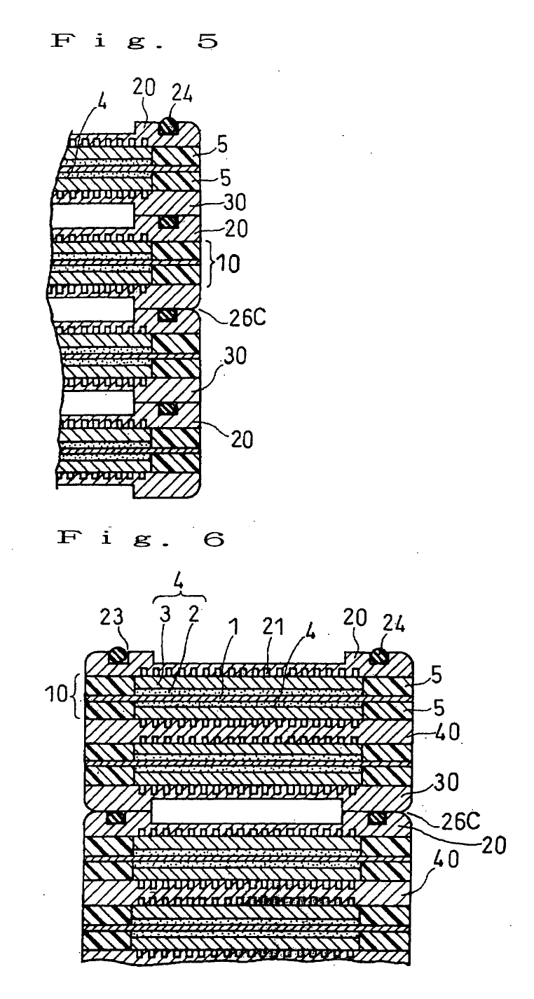

Groove 26A is formed straddling the adjoining separators 20 and 30 in the embodiment shown in FIG. 3. The grooves shown in the above-mentioned embodiments are all rectangular. Groove 26B in FIG. 4 has a wedge-shape, which straddles separators 20 and 30, in the same manner as groove 26A in FIG. 3.

Although a groove can be provided between every pair of cells (as shown in the above embodiments), it can alternatively be provided in a specified number of units, such as in every other pair of cells, as shown in the embodiment of FIG. 5. Further, the grooves can be provided only on the central part of the stack, where the replacement is difficult, without providing grooves on top and bottom parts, where replacement is comparatively easy. In this embodiment, Groove 26C is processed such that it creates a smooth, rounded edge (Radius process).

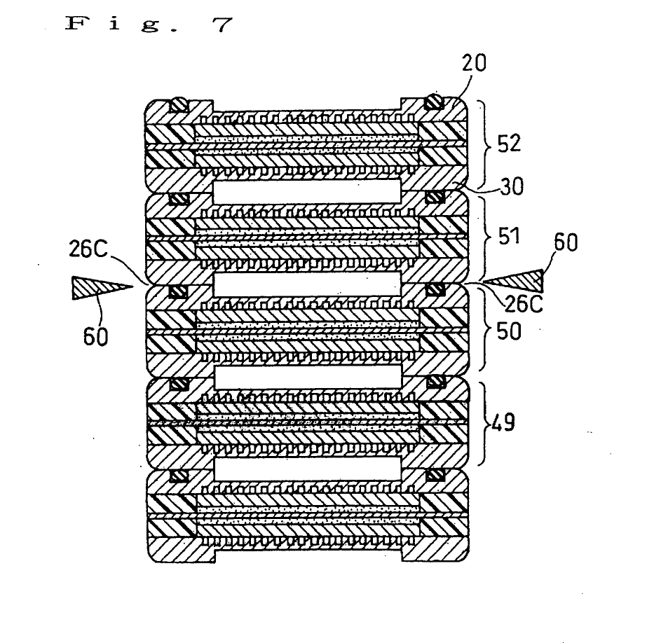

Each single cell provides an independent cathode side separator and an anode side separator in the above-mentioned embodiments. More specifically, the compound separator, which is a combination of the cathode side separator and the anode side separator, is inserted between the MEA's, so that each single cell has a configuration that it is cooled from both the cathode side and the anode side. The above-mentioned compound separator and a single separator 40 are inserted alternately between the MEA's of the embodiment shown in FIG. 6. One side of separator 40 operates as a cathode side separator, and the other side operates as an anode separator. This configuration allows a cooling channel in every other single cell. In this embodiment, two single cells can be replaced by one unit.

As above-mentioned, providing grooves between adjoining separators on at least one side of the fuel cell stack not only makes it easy for replacement of a bad single cell, but also makes possible low cost. Carbon, metal, metal-resin composites, and the like, as known in the art, can be used for the material of the separator.

Furthermore, although in the above-mentioned embodiments grooving was provided between adjoining separators on at least one of the pair of plate shaped separators, the invention is not restricted to this configuration. In other words, the grooving process can be performed on the side of the plate shaped separator where it comes into contact with the MEA. This makes it possible to realize further low-costs, since only the MEA can be replaced instead of the entire unit cell.

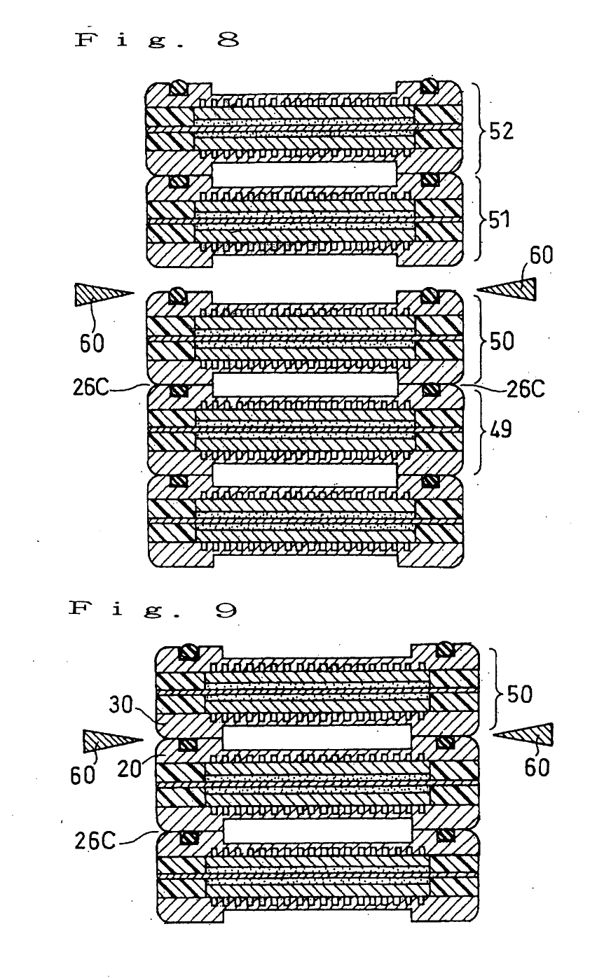

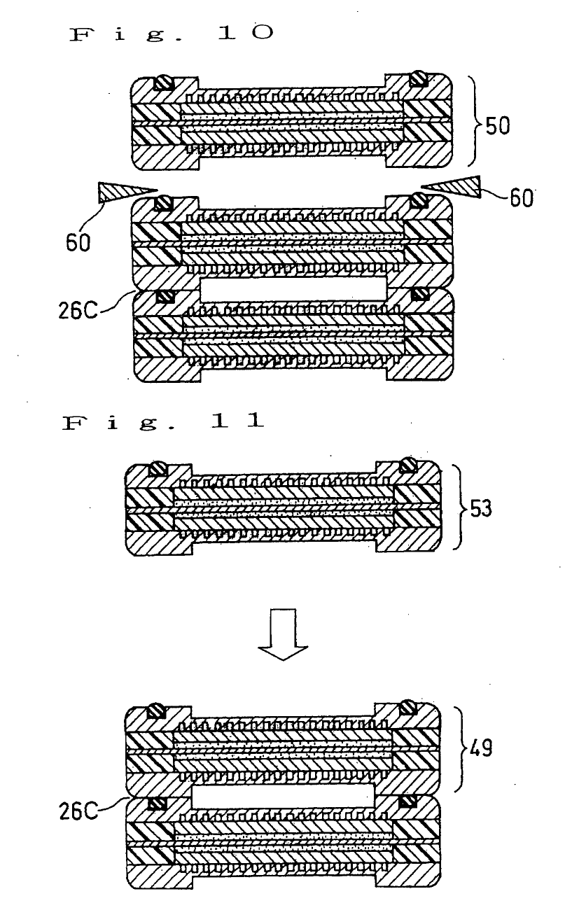

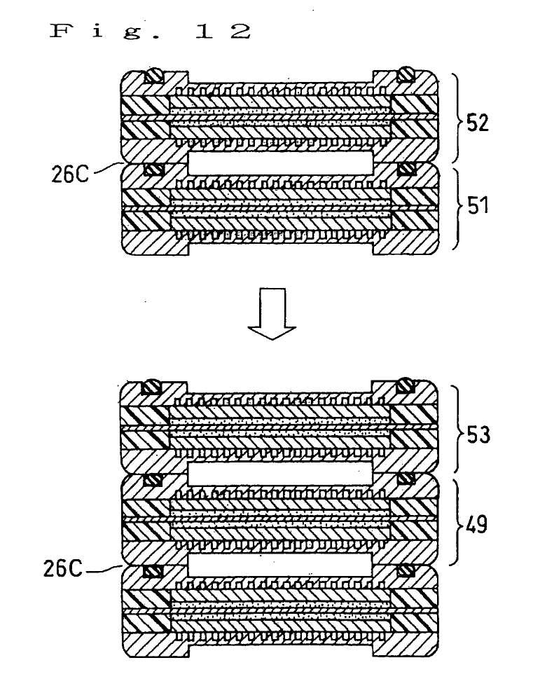

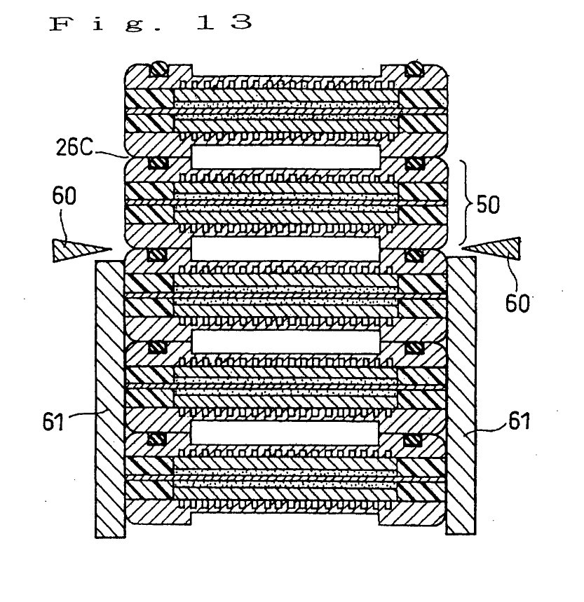

The replacement method for a bad single cell of a fuel cell stack is explained in reference to FIGS. 7-12. As shown in FIG. 7, the wedge-shaped replacement jigs 60, made of hardened resin, are inserted from two opposite sides into grooves 26C, which are between the bad single cell 50 and normal single cell unit 51, which is located right above the bad single cell unit 50, consisting of upper and lower separators. Next, normal single cell units 51 and 52, which are located above where jig 60 was inserted, are separated by pushing the jigs between the separators via the grooves and the unit cells 51 and 52 are taken off the bad single cell, as shown in FIG. 8. Subsequently, jigs 60 are inserted again right under bad single cell unit 50, which is being replaced, as shown in FIG. 9, and the bad single cell unit 50 is separated and removed in the same way, as shown in FIG. 10. After this process, replacement single cell unit 53, which is prepared in advance, is substituted for the bad cell, as shown in FIG. 11. The single cell units 51 and 52, which were taken off at the beginning of the process, are finally placed on the single replacement cell unit 53, as shown in FIG. 12. In this manner, the fuel cell stack is reassembled.

The shape of the jig used for replacement can be a thin plate instead of the wedge shape. It can be any shape which would be suitable to the method of the present invention. The material of the jig can be metal, ceramic, or other appropriate material, although hardened resin was used in the Examples in consideration of the material of and load on the separator. It is preferable that the replacement of the bad single cell be conducted by use of a fixing device, for example fixing jig 61 as shown in FIG. 13, for the fuel cell unit or stack which is located below the bad single cell unit 50, because it decreases the concern for jolting the fuel cell stack out of alignment.

As mentioned above, the fuel cell, in which a bad single cell can be easily replaced, can be obtained by providing a groove for the insertion of the jig between adjoining separators, in which the separator sides are located in the same planes as the sides of the stacked fuel cell. The processing to form the grooves in the separators can be carried out in a very simple manner and configuration.

The invention will now be illustrated and explained in more detail with reference to the following specific, non-limiting Examples with further reference to the drawings.

### EXAMPLE 1

The configuration used in the fuel cell stack of this Example is illustrated in FIG. 1. The configuration of single cells used for this fuel cell stack is explained hereinafter. The single cell was formed with carbon paper for the gas diffusion layers 3 and gaskets 5 made of fluorinated rubber after coating of catalyst layers 2 on both sides of the polymer membrane 1. The planar size of the electrode is a 12 cm square (i.e., a square of 12 cm on a side), and the size of the single cell is 18 cm square.

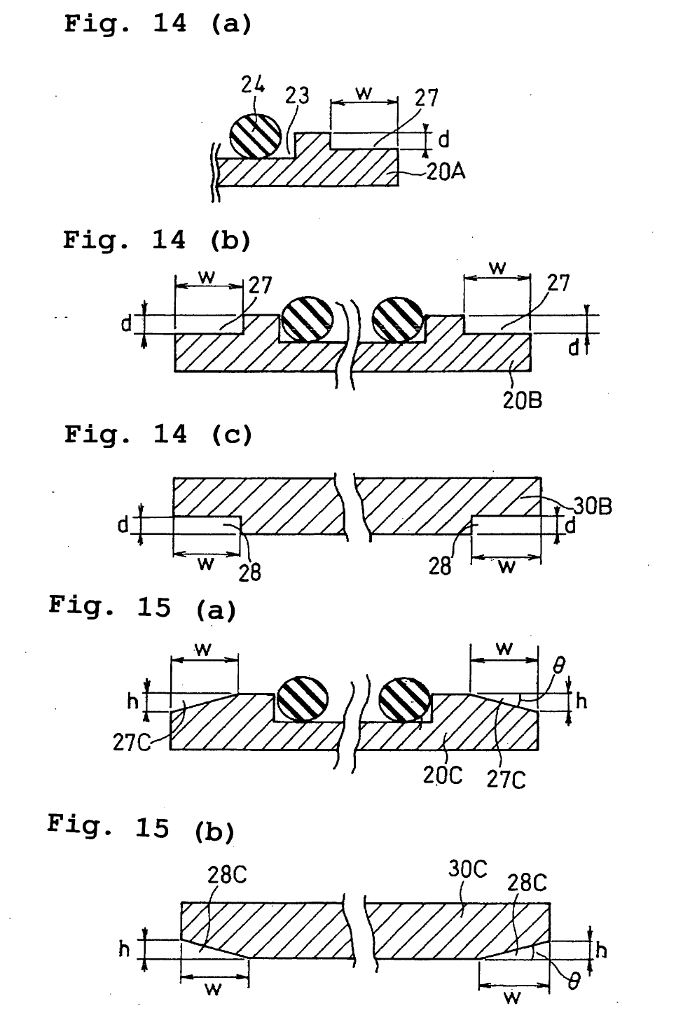

The single cell unit made in this manner was sandwiched between carbon separators 20 and 30 (18 cm square, 3 mm thick), which had a gas tight seal. Separator 20 had a fluorinated rubber o ring 24 inserted therein for obtaining a gas tight seal. Additionally, the side edge of separator 20A underwent a scraping process 27, as shown in FIG. 14 (a), to form the groove 26 of FIG. 1, having dimensions of 0.6 mm depth (d) and 2 mm width (w).

Eighty (80) of these single cell units were stacked up to create a fuel cell stack. In this process, the cross-section has a rectangular-shaped groove 26, which was formed on one of the sides of the fuel cell stack as shown in FIG. 1. Although the depth (d) and width (w) of the processed part which forms the groove were fixed to specific values, other values and any kind of shape can be selected, so long as the shape is adapted to accomplishing the replacement method of the present invention. Additionally, the shape can be changed according to the shape of the separator used.

### EXAMPLE 2

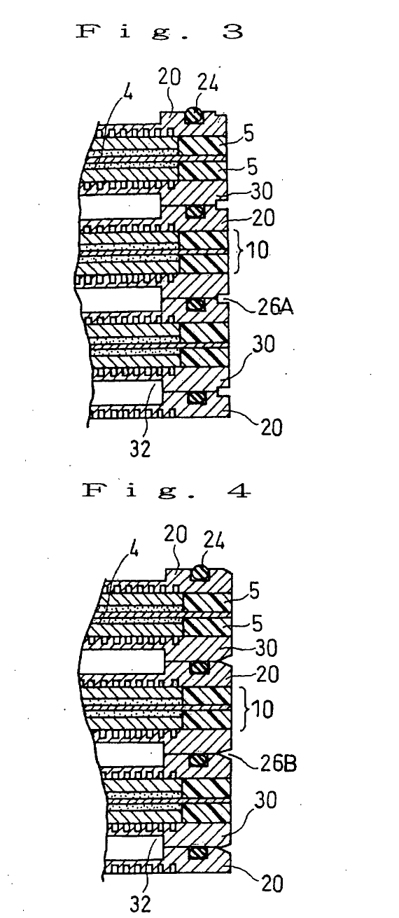

In the fuel cell of this Example the configuration of FIG. 2 was used with grooves 26 on both sides. The single cell is the same as the one used in Example 1. The single cell unit made in this manner was sandwiched between carbon separators 20 and 30 (18 cm square, 3 mm thick), which had a gas tight seal. Separator 20 had an O ring 24 inserted therein for obtaining a gas tight seal. Additionally, the side edge of separator 20B underwent a scraping process 27, as shown in FIG. 14 (b), to form the grooves 26 of FIG. 2, having dimensions of 0.6 mm depth (d) and 2 mm width (w).

Eighty (80) of these single cell units were assembled to create a fuel cell stack. In this process, the cross-section has rectangular-shaped grooves 26, which are formed on two opposed sides of the fuel cell stack, as shown in FIG. 2.

### EXAMPLE 3

In the fuel cell of this Example the configuration of FIG. 3 was used, which provided grooves 26A on two sides (only one side shown in FIG. 3). The single cell is the same as that used in Example 1. The single cell unit made in this manner was sandwiched between carbon separators 20 and 30 (18 cm square, 3 mm thick), which had a gas tight seal. Separator 20 had an O ring 24 inserted therein for obtaining a gas tight seal. The sides of both separators 20 and 30 were processed by scraping 28 to a depth (d) of 0.6 mm and a width (w) of 2 mm, as shown for the separator 30B only in FIG. 14 (c), to obtain the grooves 26A of FIG. 3.

Eighty (80) of these single cell units were assembled to create a fuel cell stack. In this process, the cross-section has rectangular-shaped grooves 26A, which were formed on two opposing sides of the fuel cell stack.

### EXAMPLE 4

In the fuel cell of this Example the configuration of FIG. 4 was used, which provided grooves 26B on two sides of the stack. The single cell is the same as that used in Example 1. The single cell unit made in this manner was sandwiched between carbon separators 20 and 30 (18 cm square, 3 mm thick), which had a gas tight seal. A chamfering process was conducted on opposing sides of both separators 20C and 30C to produce wedge-shaped grooves with generally flat side surfaces, as shown at 27c and 28c in FIG. 15 (a) and (b) respectively, to a height (h) of 0.8 mm, a width (w) of 2 mm, and an angle (θ) of 45°. Eighty (80) of these single cell units were assembled to create a fuel cell stack.

The chamfering process was carried out using the specific values of height (h) 0.8 mm, width (w) 2 mm, and angle (θ) 45°, but other values can be selected. Moreover, although the shapes of the grooves used in this Example are the same shapes on both opposing sides, different shapes can be used. The shape of the groove can also be changed in order to adapt it to the shape of the separator being used. Although only two longitudinal sides of the stack were processed in this Example, all four sides can be processed, and each side can be processed if the shape of the separator has more than four sides.

### EXAMPLE 5

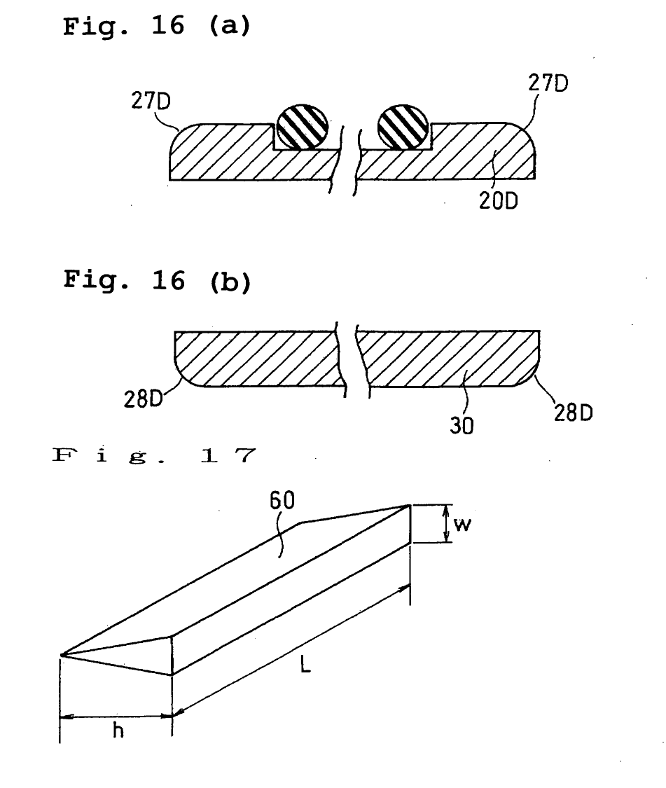

The fuel cell of this Example used the configuration of R (radius) processed groove 26 C as shown in FIG. 5, instead of wedge-shaped groove 26B shown in FIG. 4. The groove part is formed by a chamfering process to produce grooves with sides having rounded surfaces, where R=1.5 mm, as shown at 27D and 28D in FIGS. 16 (a) and (b). The other features of the fuel cell are the same as in Example 4. In this Example groove 26C was formed in every other single cell (i.e., alternate cells), as shown in FIG. 5.

### EXAMPLE 6

The configuration of FIG. 6 was used in the fuel cell of this Example. More specifically, the cooling part is provided in every other single cell (i.e., in alternate cells), and groove 26C is provided on the separator part which provides the cooling channel. The other features of the fuel cell are the same as in Example 1.

### EXAMPLE 7

The replacement of a cell unit was conducted using the method illustrated in FIGS. 7-12, using the fuel cell of Example 5.

As shown in FIG. 7, the wedge-shaped replacement jig 60, which is shown in FIG. 17 with a height (h) of 50 mm, a bottom edge with a width (w) of 20 mm, and a length (L) of 200 mm, was placed in the grooves 26C between the bad single cell unit 50 and the single cell unit 51 located just above it. As shown in FIG. 8, the single cell units 51 and 52, which are above the bad single cell unit 50, were removed after pushing the jig 60 into the grooves 26C to separate the adjacent cell units. After this, the bad single cell unit 50 was taken out by inserting the replacement jig 60 in the grooves 26C under the bad single cell unit 50, as shown in FIG. 9, and pushing the jig 60 into the grooves to separate the adjacent cells, as shown in FIG. 10. Subsequently, the prepared single cell replacement unit 53 was set on single unit cell 49, as shown in FIG. 11, and the fuel cell stack was reassembled by putting the single cell units 51 and 52 back on top of replacement unit 53 as the last step, as shown in FIG. 12.

During this replacement operation, the insertion of replacement jig 60 was easily performed with groove 26C. Moreover, separator damage was not found. On the other hand, when insertion of the replacement jig was attempted between adjoining separators of a conventional fuel cell unit stack, which did not provide a groove, the insertion was not possible because of little or no space. Subsequently, insertion was attempted in the conventional stack using a replacement jig which was the same shape, but the material of the jig was changed to metal. In this case, the jig was just barely inserted, but upon insertion the separators suffered damage, such as chipping or cracking.

Subsequently, the same replacement method was conducted for the fuel cell units of the stacks of Examples 1-4 without problems. Additionally, it was confirmed that the replacement of every two fuel cell units in the stack of Example 6 demonstrated no problems.

Although resin or metal was used as a material for the replacement jig, other materials besides these can be used. The wedge shape was used for the jig in this Example, but other shapes, such as sheet, thin plate, or the like, can be used. The size of the jig, also, is not limited to that of the present Example.

### EXAMPLE 8

In this Example the fuel cell replacement was conducted using replacement jig 60, 61 with the fuel cell unit stack of Example 4. The replacement method was the same as that used in Example 7, except the fuel cells below the bad single cell 50 were fixed in place from the beginning by the holder 61 of the jig, as shown in FIG. 13. In this case, the insertion of the wedge-shaped jig 60 for the replacement method was simplified, and because the fuel cells were fixed in place, the normal cell units were not simultaneously jolted out of alignment.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A polymer electrolyte fuel cell comprising a stack of fuel cell units, each fuel cell unit comprising a membrane electrode assembly having a solid polymer membrane sandwiched between a pair of electrode and the membrane electrode assembly being sandwiched between an anode side separator with a gas channel for supplying fuel gas to one of the electrodes and a cathode side separator with a gas channel for supplying oxidation gas to another of the electrodes, wherein grooves are provided along at least some lines where separators of adjacent fuel cell units adjoin each other or adjoin the membrane electrode assembly, the grooves being provided on at least one longitudinal side face of the stack.

2. The polymer electrolyte fuel cell according to claim 1, wherein the grooves have a generally rectangular cross sectional shape.

3. The polymer electrolyte fuel cell according to claim 1, wherein the sides of the grooves have a generally wedge-shaped cross section.

4. The polymer electrolyte fuel cell according to claim 3, wherein sides of the grooves have generally flat surfaces.

5. The polymer electrolyte fuel cell according to claim 3, wherein sides of the grooves have rounded surfaces.

6. The polymer electrolyte fuel cell according to claim 1, wherein the grooves have a size and shape to receive a replacement jig for separating the adjacent fuel cell units where the separators adjoin each other or for separating one of the separators from the membrane electrode assembly.

7. The polymer electrolyte fuel cell according to claim 1, wherein the grooves are provided on two oppositely directed longitudinal sides of the stack.

8. The polymer electrolyte fuel cell according to claim 1, wherein the grooves are provided along alternate lines where separators of adjacent fuel cell units adjoin each other.

9. The polymer electrolyte fuel cell according to claim 1, wherein the grooves are formed in only one of the separators of the adjacent fuel cell units.

10. The polymer electrolyte fuel cell according to claim 1, wherein the grooves are formed in both of the adjoining separators of the adjacent fuel cell units.

11. A method of replacing a fuel cell unit or membrane electrode assembly in the polymer electrolyte fuel cell stack of claim 1, comprising inserting a replacement jig into at least one of the grooves nearest to the fuel cell unit or membrane electrode assembly to be replaced and pushing the jig into the at least one groove to separate the adjoining separator in which the groove is located.

12. The method according to claim 11, wherein the replacement jig has wedge-shaped insertion members and the apex of the wedge-shaped member is inserted into the groove.

13. The method according to claim 12, wherein the insertion members are made of hardened resin.

14. The method according to claim 11, wherein the replacement jig is inserted into grooves of the same separator on opposite sides of the fuel cell stack.

15. The method according to claim 11, wherein the replacement jig has holding devices which, during the replacement, hold in fixed alignment at least some fuel cell units which are not to be replaced.

16. The method according to claim 11, comprising the following steps:
a) inserting the replacement jig into at least one of the grooves in the stack immediately above the fuel cell unit to be replaced;
b) separating and removing from the stack a first set of fuel cell units above the at least one groove into which the jig was inserted;
c) inserting the replacement jig into at least a second of the grooves in the stack immediately below the fuel cell unit to be replaced;
d) separating and removing from the stack the fuel cell unit to be replaced;
e) placing a replacement fuel cell unit on a second set of fuel cell units below the second of the grooves; and
f) replacing the first set of fuel cell units on the replacement fuel cell unit.
